(19) United States
(12) Patent Application Publication
(10) Pub. No.: US 2019/0270035 A1
(43) Pub. Date: Sep. 5, 2019

(54) HYDROPHOBICITY BASED FLOW PREVENTION IN SAMPLE PREPARATION

(71) Applicant: PREOMICS GMBH, Gauting (DE)

(72) Inventors: Garwin PICHLER, Munchen (DE); Nils A KULAK, Munchen (DE)

(21) Appl. No.: 16/345,642

(22) PCT Filed: Oct. 27, 2017
(86) PCT No.: PCT/EP2017/077618

§ 371 Date: Apr. 26, 2019

(30) Foreign Application Priority Data
Oct. 28, 2016 (EP) 16196329.3

(51) Int. Cl. B01D 15/22; G01N 1/40; G01N 30/60

(52) U.S. Cl. CPC B01D 15/22; G01N 30/6091; G01N 30/6026; G01N 1/405

(57) ABSTRACT

The present invention relates to a cartridge comprising or consisting of, from top to bottom, the following elements: (a) an inlet; (b) a top volume; (c) at least one optional layer made of a first material; (d) adjacent to (b) or, if present, to (c), at least one layer of chromatographic material; (e) adjacent to (d) at least one layer made of first material; and (f) an outlet; wherein said first material is hydrophobic and porous.

The present invention relates to a cartridge comprising or consisting of, from top to bottom, the following elements: (a) an inlet; (b) a top volume; (c) at least one optional layer made of a first material; (d) adjacent to (b) or, if present, to (c), at least one layer of chromatographic material; (e) adjacent to (d) at least one layer made of first material; and (f) an outlet; wherein said first material is hydrophobic and porous.

In this specification, a number of documents including patent applications and manufacturer's manuals are cited. The disclosure of these documents, while not considered relevant for the patentability of this invention, is herewith incorporated by reference in its entirety. More specifically, all referenced documents are incorporated by reference to the same extent as if each individual document was specifically and individually indicated to be incorporated by reference.

In most bio-analytical technologies crude samples cannot directly be subjected to analysis. Therefore, these technologies rely on procedures to process samples of interest prior to analysis. One part of these sample preparation procedures are sample purifications or enrichments using liquid chromatography materials which selectively retain or release compounds of interest. Especially single-use plastic consumables pre-filled with chromatography material, so called solid-phase extraction (SPE) cartridges, are commonly employed due to their low price and the low degree of cross-contaminations they cause. To control the flow across the chromatography material and to prevent backflow, such cartridges need to be closed with plugs or the like in order to prevent liquid flow.

In addition, chromatography materials may quickly dry out which may damage the material. Moreover, handling of many cartridges such as cartridges in multi-channel plate format is time consuming and difficult. In order to address these problems, plugs, stoppers, caps including screw caps, foils, luer seals and the like have been developed which have to be removed during cartridge handling; see, for example, U.S. Pat. No. 6,177,008 B1 and US 20120175368 A1.

State-of-the-art plugs or caps are only partially satisfactory. Caps or foils which are glued into place introduce plasticizers which are prone to interact with bioanalytes and contaminate the sample. Caps which “click” or lock into place often require physical force or manual interaction to remove such an enclosure. Weaker enclosures on the other hand are easily and inadvertently penetrateable. In other words, a satisfactory seal is still difficult to achieve.

In view of the deficiencies of the state of the art, the technical problem underlying the present invention can be seen in the provision of improved means and methods for controlling liquid flow in the course of sample preparation. The term “sample preparation” refers to the processing of crude samples such as bodily fluids or environmental samples such that they can be fed into analytical methods such as mass spectrometry. The mentioned liquid flow is flow of a liquid, in general a polar liquid comprising or consisting of the sample or a pre-processed sample through chromatographic media.

Accordingly, the present invention, in a first aspect, relates to a cartridge comprising or consisting of, from top to bottom, the following elements: (a) an inlet; (b) a top volume; (c) at least one optional layer made of a first material; (d) adjacent to (b) or, if present, to (c), at least one layer of chromatographic material; (e) adjacent to (d) at least one layer made of first material; and (f) an outlet; wherein said first material is hydrophobic and porous.

The term “cartridge” in accordance with the present invention defines a container which, in the absence of indications to the contrary, is open at either end. This is indicated by the terms “inlet” and “outlet”. In addition to the elements defined in accordance with the first aspect, it is understood that a cartridge, by definition, comprises a wall. Said wall (or the empty) can be manufactured of those materials which are commonly used in the manufacture of cartridges. Such materials include glass and plastic. Preferred is plastic. Preferred materials for the cartridge include Acrylonitrile Butadiene Styrene (ABS), ABS+PC (ABS+Polycarbonate Alloy), Acetal (POM) (Polyoxymethylene), Acrylic (PMMA) (Polymethyl methacrylate), LCP (Liquid Crystal Polymer), Nylon 6-PA (Polyamide), Nylon 6/6-PA (Polyamide), Nylon 11-PA (Polyamide), PBT Polyester (Polybutylene Terepthalate), PC (Polycarbonate), PEI (Polyetherimid), PE (Polyethylene), LDPE (Low Density Polyethylene), HDPE (High Density Polyethylene), PET Polyester (Polyethylene Terepthalate), PMP (Polymethylpentene), PP (Polypropylene), PPA (Polyphthalamide), PPS (Polyphenylene Sulfide), PS (Polystyrene), HIPS (High Impact Polystyrene), PSU (Polysulfone), PU (Polyurethane), PVC (Polyvinylchloride), PVDF (Polyvinylidene Fluoride) and SAN (Styrene Acrylonitrile). Particularly preferred are polycarbonate and polypropylene. Most preferred is polypropylene.

While it is possible to manufacture cartridges wherein for different segments of the cartridge different wall materials are used, preference is given to cartridges wherein the wall material is the same throughout. A typical method of manufacturing empty cartridges (i.e. cartridges consisting only of wall material) is injection moulding. It is understood that inlet and outlet are preferably manufactured from the same wall material as the remainder of the wall of the cartridge.

Preferably, said cartridge is disposable. Preferably, said cartridge does not allow exchanging of any of the layers. Preferably, the elements of said cartridge are welded together.

Preferred is exactly one layer (d) of chromatographic material.

The top volume (element (b) of the cartridge) receives the sample to be subjected to sample preparation. It may also serve as a reaction chamber, in particular in those instances where the sample, prior to being subjected to chromatography, shall undergo pre-processing. If the top volume shall serve as a reaction chamber, it is preferred that layer (c) of the cartridge is present. Presence of said layer (c) is a means to ensure that no flow of liquid into the chromatography material occurs while the reaction is still taking place. Envisaged reagents to be added to the reaction chamber are detailed further below.

Preferred total volumes of the cartridge are between about 0.01 and about 100 ml, more preferably between about 0.1 and about 5 ml, such as between about 0.5 and about 2 ml including about 1 ml. Preferred cross sections of the cartridge are between about 1 and about 100 mm or between about 2 and about 50 mm, such as between about 3 and about 30 mm including between about 5 mm and about 10 mm. Exemplary cross-sections are 4.4, 8 and 25 mm. Preferred top volumes or reaction volumes, respectively, are between about 0.001 and about 100 ml, preferably between about 0.05 ml and about 30 ml, more preferably between about 0.3 and 3 ml, such as about 1 ml or about 2 ml.

The terms “top”, “bottom”, “underneath” and “above” are all used in relation to the flow of the liquid sample subjected to chromatography. Accordingly, in the course of chromatography, liquid flows from top to bottom.

Underneath the top volume, there is a plurality of layers, wherein a minimum of two layers has to be present. These layers are defined by optional item (c), and comprising items (d) and (e). In the simplest implementation, one chromatographic material layer in accordance with (d) and the layer in accordance with (e) is present. As will become apparent further below, more than one layer of chromatographic material may be used. Accordingly, a further implementation provides for two layers in accordance with (d) and one layer in accordance with (e). In preferred embodiments, also the optional layer (c) is present. This provides for implementations wherein layer (c), one layer (d), and a layer (e) are present. Yet further, deliberately envisaged are configurations with a layer (c), two or more layers (d) and one layer (e).

In case of two or more layers (d), one or more further layers of first material may be present between layers (d). Preferably, said one or more further layers of first material between layers (d) are not movable.

Which material or which materials are to be chosen for one or more layers in accordance with (d) will depend on the sample to be prepared and the analytical method to which the processed sample is to be subjected to. The choice of appropriate chromatographic materials can be done by the skilled person without further ado. Preferred chromatographic materials are disclosed further below.

Chromatographic material may be slurry beads. Chromatographic material may also be embedded in an inert material, e.g. for ease of handling. Said inert material may be a first material in accordance with the invention. To the extent use is made of embedded chromatographic material, preference is given to cartridges with exactly one layer (d). To the extent use is made of more than one layer (d), preference is given to slurry beads for each of the layers (d).

Layer (e) and the optional layer (c) are those means in accordance with the present invention which provide for the control of liquid flow. This will be explained in more detail below.

Layers made of first material preferably consist of first material.

Alternatively, one, more or all of said layers made of first material comprise, in addition to said first material, further constituents. Preferred further constituents include C18 material and poly-styrene divinyl benzene material, preferably in the form of beads, said beads being embedded in said first material.

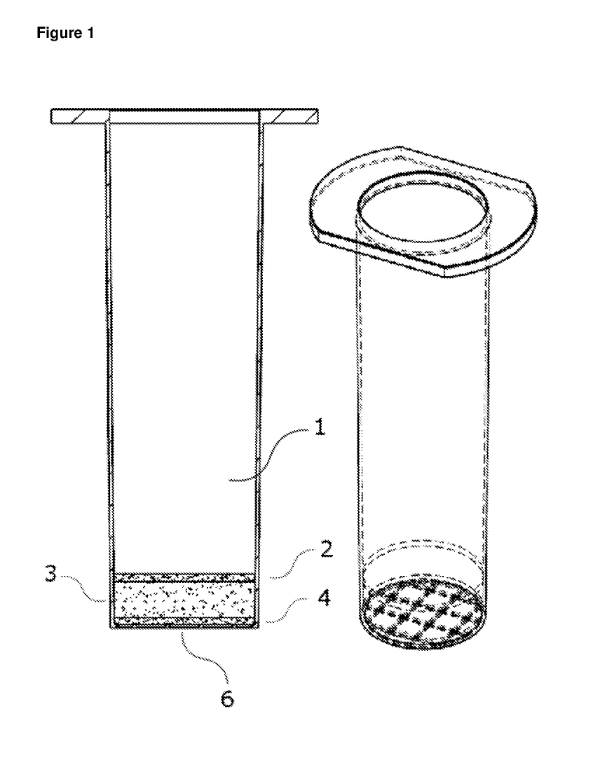

Exemplary cartridges in accordance with the present invention are depicted in FIGS. 1 to 3.

The cartridge in accordance with the first aspect is designed for sample preparation. Sample preparation is generally for analytical methods. A preferred analytical method is mass spectrometry. Preferred analytes are peptides, polypeptides and proteins. Envisaged are also analytes which are nucleic acids or small organic molecules such as drugs and metabolites. Preferred metabolites are alcohols such as ethanol; amino acids such as glutamic acid and aspartic acid; nucleotides such as 5′ guanylic acid; antioxidants such as isoascorbic acid; organic acids such as acetic acid and lactic acid; polyols such as glycerol; and vitamins such as vitamin B₂.

Detection of metabolites is of particular interest in a number of disorders which disorders are characterized by levels of metabolites which deviate (either increased or decreased) from the level observed in healthy individuals. For example, metabolic disorders where metabolites which are organic acids can be analysed by mass spectrometry include 3-hydroxy-3-methylglutaryl-CoA lyase deficiency (HMG); glutaric acidemia type I (GA I); isobutyryl-CoA dehydrogenase deficiency; isovaleric acidemia (IVA) such as acute onset IVA and chronic IVA; 2-methylbutryl-CoA dehydrogenase deficiency; 3-methylcrotonyl-CoA carboxylase deficiency (3MCC deficiency); 3-methylglutaconyl-CoA hydratase deficiency; methylmalonic acidemias such as methylmalonyl-CoA mutase deficiency 0, methylmalonyl-CoA mutase deficiency+, adenosylcobalamin synthesis defects and maternal vitamin B12 deficiency; mitochondrial acetoacetyl-CoA thiolase deficiency (3-ketothiolase deficiency); propionic acidemia (PA) such as acute onset PA and late onset PA; multiple-CoA carboxylase deficiency; and malonic aciduria.

Metabolic disorders where deviant levels of amino acids occur and can be determined by means of mass spectrometry include argininemia; argininosuccinic aciduria (ASA lyase deficiency) including acute onset ASA lyase deficiency and late onset ASA lyase deficiency; carbamoylphosphate synthetase deficiency (CPS deficiency); citrullinemia (ASA synthetase deficiency) such as acute onset ASA synthetase deficiency and late onset ASA synthetase deficiency; homocystinuria; hypermethioninemia; hyperammonemia, hyperornithinemia, homocitrullinemia syndrome (HHH); hyperornithinemia with gyral atrophy; maple syrup urine disease (MSUD) such as classical MSUD and intermediate MSUD; 5-oxoprolinuria (pyroglutamic aciduria); phenylketonuria (PKU) including classical PKU, hyperphenylalaninemia and biopterin cofactor deficiencies; tyrosinemia; and transient neonatal tyrosinemia including tyrosinemia type I (Tyr I), tyrosinemia type II (Tyr II) and tyrosimenia type III (Tyr III).

Metabolites involved in fatty acid oxidation of interest for diagnosing are based on a sample taken from an individual, disorders including carnitine/acylcarnitine translocase deficiency (translocase); carnitine palmitoyl transferase deficiency type I (CPT-I); 3-hydroxy long chain acyl-CoA dehydrogenase deficiency (LCHAD); 2,4-dienoyl-CoA reductase deficiency; medium chain acyl-CoA dehydrogenase deficiency (MCAD); multiple acyl-CoA dehydrogenase deficiency (MADD or glutaric acidemia-type II); neonatal carnitine palmitoyl transferase deficiency type II (CPT-II); short-chain acyl-CoA dehydrogenase deficiency (SCAD); short-chain hydroxy acyl-CoA dehydrogenase deficiency (SCHAD); trifunctional protein deficiency (TFP deficiency); and very long chain acyl-CoA dehydrogenase deficiency (VLCAD).

As noted above, the term “sample preparation” refers to the processing of crude samples such as bodily fluids or environmental samples such that they can be fed into analytical methods such as mass spectrometry. More specifically it relates to purification or enrichment of analytes. Sample preparation is not necessarily confined to enrichment or purification, though. It may include physical, physicochemical and/or chemical pre-processing. Pre-processing preferably occurs in the top volume. Pre-processing preferably precedes chromatography. In those instances where the sample is to be pre-processed prior to chromatography, it is generally necessary or desirable to ensure that pre-processing is complete prior to the beginning of chromatography.

In the course of sample preparation, it may become necessary to control temperature and/or change temperature. A common means of controlling and/or changing temperature is a water bath. In order to control or change temperature, the cartridge has to be immersed into a water bath, at least partially. This entails the need to control, more specifically prevent, the backflow of water from the water bath into the cartridge.

For proper functioning of the chromatographic layer in the course of sample preparation, it is necessary that the chromatographic material remains wet, including the period of storage of the cartridge prior to its use for chromatography.

In many instances, it is desirable to control not only flow, but also flow rate through the chromatographic medium. This can be done, for example, by fine-tuning pressure, vacuum and/or gravitational force.

In certain applications, it is desirable to store a sample already within the cartridge to be used for preparation of the sample for an analytical method, said preparation to be effected at a later point in time.

As noted above in the introductory part of this disclosure, art-established means for addressing the above issues exist, but suffer from several deficiencies. The present invention renders plugs, caps, foils, clasps and the like (herein collectively referred to as “seal”) dispensable. The present invention uses one or more layers of hydrophobic and porous material in order to control liquid flow, in particular the flow of polar liquids.

Hydrophobicity of the material provides for the prevention of flow under first conditions, said first conditions preferably being ambient pressure of 101325 Pa±10% or 101325 Pa±5% and a temperature of 24° C.±10%, 24° C.±5%, or room temperature of 24° C. Particularly preferred first conditions are a pressure of 101325 Pa and a temperature of 24° C.

Upon a change of conditions to second conditions, said second conditions preferably characterized by a pressure which is elevated as compared to ambient pressure, flow of liquid is initiated. Flow of liquid is possible because the first material in accordance with the first aspect is required to be porous. Initiation of flow occurs because, owing to elevated pressure, application of vacuum and/or centrifugal force, the force acting on the liquid and pushing it towards elements (c), (d) and (e) of the cartridge exceeds the force at the interface between the liquid and the first material of (e) and, if present, of (c).

Initiation of liquid flow does not require removal of a cap or otherwise opening the cartridge. In fact, in a preferred embodiment, the cartridge in accordance with the present invention is already and always open, i.e., in particular inlet and outlet are not equipped with a plug or cap or the like.

In an embodiment, the inlet is equipped with a seal such as a plug, cap or foil while the outlet is not.

It is understood that liquids to be processed in the cartridge of the invention are polar liquids. In particular, they are less hydrophobic than the hydrophobic first material. Preferred polar liquids include water, aqueous solutions and buffered solutions.

In a preferred embodiment, the layers of (e) and, if present, of (c) prevent the flow of a polar liquid with a surface tension of at least 35 mN/m, at least 50 mN/m or at least 70 mN/m under said first conditions, especially at ambient pressure, and allow the flow of said polar liquid through said disk(s) at elevated pressure, and/or when vacuum and/or centrifugal force is applied. It is understood that preferably only pressure is changed (by one or more of the recited means, i.e. including vacuum and centrifugal force) and temperature (preferably room temperature) (as well as any other conditions) remain unchanged.

Not only can flow of polar liquid be initiated by these means, but also can the flow rate be controlled. This can be done, for example, by fine-tuning pressure, vacuum and/or gravitational force once and/or changing these conditions gradually and/or stepwise as a function of time.

It is understood that the term “polar liquid” refers to a liquid which is less hydrophobic than a given first material under consideration. For example, pure water has a surface tension of about 72 mN/m. Presence of solutes in water generally modifies, in several instances lowers, the surface tension. A polar liquid preferably has a surface tension of at least 35 mN/m, at least 40 mN/m, at least 45 mN/m, at least 50 mN/m, at least 55 mN/m, at least 60 mN/m, at least 65 mN/m, or at least 70 mN/m.

Given that the liquid is polar and the first material hydrophobic, there is no flow of liquid under said first conditions. Liquid flow may be initiated, however, by increasing pressure. The extent to which pressure has to be increased will depend on polarity of the liquid, and the hydrophobicity and porosity of the first material. This is illustrated in the examples further below. Preferred measures and extents of raising pressure are disclosed further below. It is of note, though, that the skilled person, provided with the teaching of the present invention, can choose without further ado or determine by simple experiments how much pressure needs to be raised in order to initiate liquid flow for a given polar liquid and a given hydrophobic and porous material.

In a further preferred embodiment, said elevated pressure is at least 10 000 Pa above ambient pressure, preferably at least 20 000 Pa, at least 30 000 Pa, at least 40 000 Pa, at least 50 000 Pa, at least 60 000 Pa, at least 70 000 Pa, at least 80 000 Pa, at least 90 000 Pa or at least 100 000 Pa above ambient pressure, or a consequence of centrifugation with at least 50×gₙ (corresponds to approximately 490 N/kg) or at least 500×gₙ, wherein said elevated pressure may be exerted from above and/or as vacuum from below, and wherein preferably said polar liquid is water.

gₙ is the standard acceleration on the surface of the earth owing to gravity. gₙ=9,80665 N/kg. 100 000 Pa are also referred to as 1 bar.

The preferred values of 10 000 Pa and 100 000 Pa, respectively, correspond to preferred values of 50 gₙ and 500 gₙ, respectively, based on the following assumption: a typical fluid volume to be processed is 300 μl which approximately has a weight of 300 μg. A typical cross section of a cartridge in accordance with the invention is 15 mm². These parameter values also correspond to those of the examples below.

The above embodiments relating to elevated pressure, vacuum and centrifugal force provide a functional definition of the first hydrophobic and porous material as well as of the interplay between said first material and the polar liquid to be processed in the course of sample preparation. In other words, the generic requirement for said first material to be hydrophobic and porous enables the skilled person, when confronted with the task to perform sample preparation with a sample which is a polar liquid, to choose one or more appropriate first materials. For example, the skilled person can test a candidate first material under first conditions, first conditions preferably being as defined above, e.g. ambient pressure and room temperature, and confirm that no liquid passes through said first material. In a second trial, the skilled person can subject the same polar liquid and the same candidate first material to elevated pressure, vacuum and/or centrifugal force and observe whether flow of the polar liquid across the first material can be triggered. If this is the case, the candidate first material is a first material in accordance with the present invention and useful for processing of at least the polar liquid which has been assessed in the trial experiments.

In a further preferred embodiment, (a) the pores of said first material have a width of between about 1 nm and about 20 μm, preferably between about 0.01 μm and about 5 μm, such as about 1 μm, about 2 μm, about 3 μm or about 4 μm, most preferred between about 0.22 μm and about 1 μm; (b) the contact angle of water on a surface of said first material is at least 90 degrees, preferably at least 100 degrees, more preferably at least 110 degrees; and/or (c) the surface energy of said first material is 70 mN/m or less, preferably 50 mN/m or less or 30 mN/m or less, more preferably about 20 mN/m or less.

Particularly preferred pore widths in accordance with item (a) are those commonly provided by manufacturers, namely 0.22 μm, 1 μm and 5 μm. Having said that, pore sizes may be significantly smaller as they are used, for example, in molecular weight cut off filters. Pore widths (as well as hydrophobicity) may be chosen and fine-tuned in view of a given application.

The contact angle of a droplet of liquid on a surface is a function of the surface energy of the surface and the surface tension of the liquid.

In accordance with item (b), the liquid is water. As a consequence, the contact angle is a function of the hydrophobicity of the material. A contact angle of 110° is generally observed for a water droplet on a Teflon surface. The recited values define preferred ranges. That is, a preferred range for the contact angle of water on the surface of said first material is between 90° and 110°, or between 90° and 100°, or between 100° and 110°. It is understood that the present disclosure also extends to contact angles within said ranges, for example, 91°, 92°, 93°, 94°, 95°, 96°, 97°, 98°, 99°, 100°, 101°, 102°, 103°, 104°, 105°, 106°, 107°, 108°, and 109°. Of course, also higher contact angles are deliberately envisaged. Higher contact angles can be achieved, for example, with superhydrophobic surfaces which are subject of a preferred embodiment disclosed further below. Accordingly, contact angles of at least 120°, at least 130°, at least 140° and at least 150° are also preferred.

Item (c) discloses preferred values of the surface energy of the first material. 20 mN/m is a typical value for Teflon. Generally speaking, the lower the surface energy of the first material and the higher the surface tension of the polar liquid, the higher the contact angle will be. For example, the low surface energy of about 20 mN/m provides for a contact angle of the water droplet of about 110°. As noted above, water has a surface tension of about 72 mN/m.

In a further preferred embodiment, said first material of (e) and, if present, of (c), are independently selected (a) from polytetrafluorethylene (PTFE), perfluoroalkoxy alkane (PFA), and fluorinated ethylene propylene (FEP), wherein preferably said material is provided as a membrane (b) C18 material, C8 material, C4 material and benzene, wherein preferably said first material is bound to beads or to a membrane, and wherein more preferably said layer(s) is/are Empore™ SDB-XC extraction disks; and (c) superhydrophobic particles made of manganese oxide polystyrene (MnO₂/PS) nano-composite, zinc oxide polystyrene (ZnO/PS) nano-composite, precipitated calcium carbonate, carbon nano-tube structure, fluorocarbon nano-composites, and/or silica, wherein preferably said particles form a coating of said layer(s) of chromatographic material. These materials are available from various manufacturers such as Sigma Aldrich, Cytonix, Aculon, Formacoat, Nanobiz and mknano.

The above recited beads can be made of any material. Suitable materials are known in the art. Preferred materials are silica and poly(styrene divenylbenzene) copolymer. Beads are coated with the above recited first materials such as, for example, C18 material.

As a general note, item (e) of the cartridge in accordance with the first aspect may be implemented as a single layer of a single first material. Alternatively, item (e) may be implemented as two adjacent layers made of the same first material or as two adjacent layers of two different first materials. The same applies mutatis mutandis to item (c) of the cartridge of the invention, to the extent item (c) is present.

The above preferred embodiment is grouped into three groups owing to the relatedness between the materials within one group. Having said that, in a cartridge of the invention, said materials can be freely combined, not only within a given group, but also across groups. To give an example, the cartridge of the invention may comprise item (c), wherein item (c) is implemented as a coating of the layer of chromatographic material (d) with superhydrophobic particles. In the same cartridge, item (e) may be implemented, for example, as a SDB-XC disc.

A particularly preferred first material is PTFE.

A particularly preferred cartridge of the invention comprises or consists of, from top to bottom, the following elements: (a) an inlet; (b) a top volume; (d) adjacent to (b) a layer of chromatographic material, preferably in the form of slurry beads; (e) adjacent to (d) a layer made of PTFE; and (f) an outlet.

A further particularly preferred cartridge in accordance with the invention comprises or consists of, from top to bottom, the following elements: (a) an inlet; (b) a top volume; (d) adjacent to (b) a layer of chromatographic material, preferably incorporated into a first material such as PTFE; (e) adjacent to (d) a layer made of PTFE; and (f) an outlet.

For both particularly preferred embodiments described above, an optional layer (c) made of PTFE may be present.

Chromatographic material, when incorporated into a first material such as PTFE, may also be referred to as “disk”; see the preferred embodiment relating to SDB-RPS disks disclosed further below.

In a further preferred embodiment, the layers are disks having a thickness of between about 0.5 and about 20 mm, preferably between about 1.5 and about 2.5 mm, most preferred about 2 mm.

Higher values of thickness up to 20 mm are typically of use for the layer of chromatographic material (d). As regards layers (e) and, if present, (c), smaller values are generally preferred.

In a further preferred embodiment, said chromatographic material of (d) is ion exchange material and preferably selected from strong cation exchange material (SCX), weak cation exchange material (WCX), strong anion exchange material (SAX) and weak anion exchange material (WAX); preferably from mixed-phase material such as material with both reversed phase and ion exchange character including sulfonated solid phase extraction (SPE) material such as sulfonated poly-divinyl benzene (sulfonated DVB) or sulfonated poly-styrene divinyl benzene (sulfonated SDB); Empore™ SDB-RPS extraction disks being particularly preferred. The materials are available from various manufacturers including Sigma Aldrich.

In a further preferred embodiment, two layers of chromatographic material are present. Said two layers may be of the same type, i.e. of the same material, or may be of different material.

In a particularly preferred embodiment, two layers of identical chromatographic material are used to implement item (d), and one layer of first material is used to implement item (e). Item (c) may be absent. Said two layers of chromatographic material (d) may be group SDB-RPS extraction disks, and said layer of first material (e) may be an SDB-XC disk. Such setup may be combined, but does not have to be combined with a layer of first material (c) which preferably is also an SDB-XC disk.

While it is envisaged to use further layers of first material between layers of chromatographic material, this is not preferred in those cases where disks are used to implement the layers (d).

In a further preferred embodiment, below (e) and above or level with (f) there is a grid, preferably with a grid spacing between about 0.05 and about 2 mm.

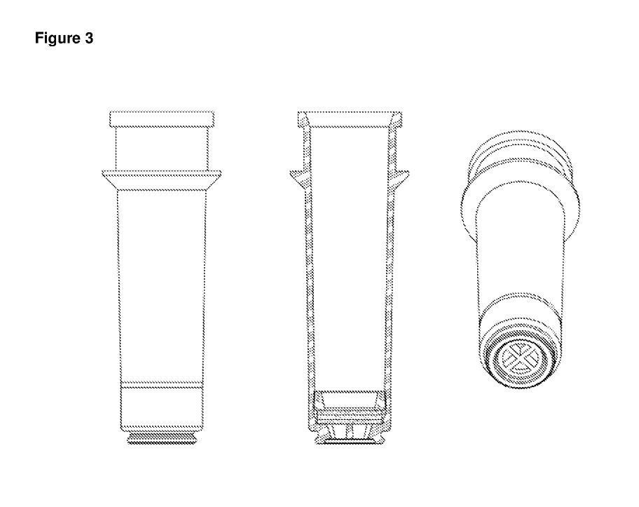

Grids are illustrated in FIGS. 1 and 3. In preferred embodiment, such grid is manufactured from the same material as the remainder of the cartridge. As noted above, a particularly preferred material is polypropylene.

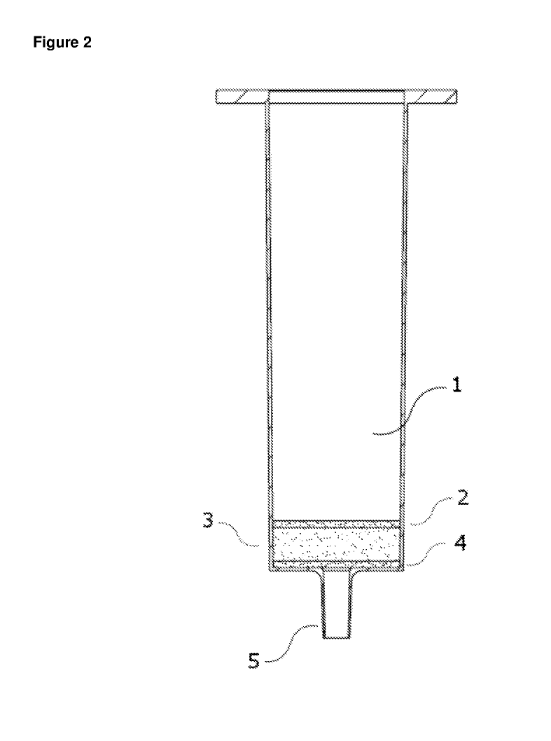

Accordingly, it is understood that said grid is inert. It is a means of keeping layers (d), (e) and, if present (c) in place. It provides for an alternative to the syringe-like design which is depicted in FIG. 2. A grid is dispensable in a syringe-like design. The design of FIG. 1 is preferred over the design of FIG. 2.

Further preferred grid spacings are between about 0.1 and about 1 mm, such as about 0.5 mm. The bars forming the grid also have a certain thickness themselves. Preferred bar thicknesses are between about 0.01 and about 0.1 mm. FIG. 3 shows a simple grid for a cartridge in accordance with the present invention which cartridge has a small cross-section (about 1 mm).

In a further preferred embodiment, said cartridge is open at either end.

In a further preferred embodiment, the segment of said cartridge comprising or consisting of elements (c), (d) and (e) has constant width and/or is cylindrical, wherein preferably said segment further comprises or further consists of element (b), and wherein more preferably said segment further comprises or further consists of elements (a) and/or (f).

Particularly preferred is that the outlet (f) is included in said segment. In other words, the outlet has the same or substantially the same cross-section as the remainder of the cartridge. A particularly preferred cartridge in accordance with the invention is a constant cross-section cartridge. Such cartridge has the same or substantially the same cross-section throughout, including inlet and outlet. As can be seen, for example in FIG. 3, for technical reasons the cross-section of the outlet might not necessarily be exactly the same as the cross-section of the remainder of the cartridge. Yet, also in such cases, the cross-section of the outlet is substantially the same as the cross-section of the cartridge. The term “substantially”, in a preferred embodiment, allows for deviations up to 20%, up to 15%, up to 10% or up to 5% from identity.

In a further preferred embodiment, said layer of (c) is present, thereby rendering said top volume (b) a reaction volume.

A preferred reaction is sonication. Sonication can be done in a water bath. Sonication can be used to break up cells.

In one embodiment, the reaction volume of the cartridge of the invention can be filled with one or more reagents. Such cartridge is also referred to as “pre-filled cartridge” herein. This means that the cartridge, more specifically the reaction volume, contains reagents prior to addition of a sample.

Preferred analytes comprised in said samples are peptides, polypeptides and proteins. In these cases, preferred reagents are one, two, more or all selected from (i) a detergent, preferably SDC; (ii) a reducing agent, preferably TCEP; (iii) an alkylating agent, preferably chloroacetamide; (iv) means to establish a pH-value between 7 and 9, preferably 8 and 9, more preferably 8.5; (v) a standard for mass-spectrometric analysis; (vi) a chaotropic agent, preferably GdmCl; (vii) an analyte stabilizing chemical such as an antioxidant and/or a UV-absorbant; and (viii) at least one enzyme selected from proteases, preferably trypsin and/or Lys-C; glycosidases, preferably PNGase F; and kinases.

To the extent the analytes of interest in the sample to be processed are or comprise nucleic acids, preferred reagents are one, two, more or all of the following: (i) one or more nucleases, preferably including an endonuclease; (ii) reagents for nucleic acid amplification, preferably by PCR; and (iii) the means to establish a pH-value between 8 and 9, preferably 8.5.

A preferred detergent is sodium deoxycholate (SDC).

Preferred reducing agents are phosphine-based reducing agents such as Tris (2-carboxyethyl) phosphin (TCEP).

Preferred alkylating agents are iodoacetamide and chloroacetamide. Particularly preferred is chloroacetamide (CAA).

Particularly preferred is the combined use of an alkylating agent which is CAA and a reducing agent which is TCEP.

The pH-value may be established by pre-filling the container with buffer material, either in the form of a buffered aqueous solution or in the form of the dry constituents required for the preparation of a buffered solution.

A preferred standard for mass spectrometric analysis is a heavy isotope mixture of analytes of interest. This can be heavy isotope labelled peptides, polypeptides, proteins, metabolites and/or other small molecules.

In a further preferred embodiment, (a) the segment of said cartridge comprising or consisting of elements (c), (d), (e) and preferably (b), more preferably further comprising or further consisting of (a) and/or (f), is not tapered; (b) said cartridge, in particular said inlet and said outlet are not equipped with any seal; and/or (c) said layers(s) made of first material is/are not (a) frit(s).

Item (a) of this preferred embodiment clarifies that a cartridge, by definition, is not tapered like, for example, a pipette tip would be.

Item (b) further underlines a salient feature of the present invention, namely that the use of hydrophobic layer(s) render(s) any seal such as plugs and the like dispensable.

Item (c) clarifies that it is the hydrophobicity of the first material which distinguishes the invention from art-established cartridges with frits. Frits, as known in the art, are typically made of glass or ceramic, i.e. silica-based or silica-containing materials. Such frits do not prevent the flow of polar liquids. They can be used to keep chromatographic material in place. Frits cannot prevent running dry of chromatographic material.

As noted above, the present invention provides improved means for controlling the flow of polar liquids in the course of sample preparation. The above discussed advantages of the invention provide for several inventive uses each of which define a separate aspect of the present invention and are detailed further below.

Accordingly, in a second aspect, the present invention provides the use of the cartridge of any one of the preceding claims for controlling flow of polar liquid through the chromatographic material of (d). “Controlling flow” refers to initiating and/or stopping flow, but may also extend to controlling the flow rate. The envisaged means for control of flow are disclosed further above.

In a third aspect, the present invention provides the use of the cartridge of any one of the preceding claims for preventing backflow of polar liquid from below the disk of (e) such as backflow of water from a water bath.

A water bath is commonly used, for example, to maintain a constant temperature and/or for sonication. What applies in terms of flow control to passage of polar liquid from the top volume or reaction volume through layers (c), (d) and (e) applies mutatis mutandis to backflow of polar liquid through outlet (f) back into the cartridge. I.e., under first conditions as defined above, especially at ambient pressure, layer (e) prevents backflow. Obviously, when applying pressure from top to bottom, backflow does not occur either. Art-established cartridges, such as for sample purification, are not equipped with means for preventing backflow.

On the other hand, there are defined applications, where reverse flow of polar liquid, i.e. from bottom to top, is desirable. An example is filling of the cartridges with a polar liquid such as a buffer solution, wherein said filling is preferably done automatically, for example by a handling robot. To explain further, when robotic devices are used, it is generally easier to suck in liquid from bottom to top than fill in liquid via the inlet. For such filling to occur, the handling device or handling robot applies negative pressure, i.e. vacuum which allows flow of polar liquid from bottom to top which flow of polar liquid is not possible under first conditions such as ambient pressure and room temperature.

In a fourth aspect, the present invention provides the use of the cartridge of any one of the preceding claims for storage of polar liquids, polar liquids preferably being biological samples, biological samples preferably comprising peptides, polypeptides and/or proteins.

The cartridge permits to keep the chromatography material wet. When a polar liquid, such as a polar liquid which is a biological sample, is stored in the cartridge, more specifically within the chromatography material comprised in said cartridge, it has reduced contact to oxygen. As such, storage of biological samples in cartridges of the invention is especially of interest if the analytes are sensitive to oxidation, degradation by light, modification owing to chemical interactions and/or contamination by the environment.

In a fifth aspect, the present invention provides the use of the cartridge of any one of the preceding claims, wherein said disk of (c) is present, for retaining polar liquids above said disk of (c).

Uses in accordance with the fifth aspect include those uses where prior to performing chromatography, one or more reactions are performed in the reaction volume.

In a sixth aspect, the present invention provides the use of the cartridge of any one of the preceding claims for preventing the chromatographic material of (d) from drying, wherein drying is the loss of a polar liquid such as water or a buffered solution.

In a preferred embodiment of the above uses, said polar liquid has a surface tension of at least 35 mN/m, preferably at least 50 mN/m or at least 70 mN/m.

In a seventh aspect, the present invention provides a method of sample preparation, said method comprising: (a) transferring a sample to a cartridge of any one of the preceding claims via the inlet of said cartridge; and (b) applying pressure, vacuum and/or centrifugal force; thereby preparing said sample.

It is understood that said applying pressure, vacuum or centrifugal force is to be effected such that the liquid sample passes from top to bottom through the chromatographic medium.

In other words, the applied force, be it pressure, vacuum or centrifugal force, either points from top to bottom of the cartridge or has at least a component which points from top to bottom.

The sample is or comprises a polar liquid. Preferred samples are those disclosed herein above and comprise peptides, polypeptides and/or proteins. Samples may also comprise nucleic acids.

As noted above, exerting pressure, vacuum and/or centrifugal force is a means of initiating flow of polar liquid. As can be seen from the examples, depending on the conditions and the material chosen, different time intervals are necessary in order to ensure that the whole amount of polar liquid passes through the chromatographic medium. Accordingly, if preparation of the complete sample is desired, the time interval is chosen such that the whole amount of polar liquid passes through the chromatographic medium. Suitable time intervals can be determined without further ado, for example by conducting a series of tests with a given polar liquid, given materials (first material(s) and chromatographic material(s)) and a given pressure, vacuum and/or centrifugal force.

It is preferred to use centrifugal force in step (b). A preferred first material is PTFE with a pore width between 1 and 2 μM. When using this preferred material, centrifugation at 3000 gₙ for 10 minutes or less, preferably for one minute, is preferred in order to ensure that a liquid volume of about 300 μL passes through the chromatographic medium in its entirety.

Centrifugation at 3000 gₙ for 10 minutes or less, preferably for one minute is also suitable when SDB-XC disks are used.

In a preferred embodiment of the method of the invention, said method furthermore comprises one or both steps (aa) and (bb): (aa) after step (a) and prior to step (b), adding one or more reagents and/or allowing (a) reaction(s) to occur, wherein preferably said layer (c) of said cartridge is present; and (bb) collecting the eluate flowing from the outlet of said cartridge, optionally after changing conditions, said collecting optionally comprising fractionating.

Preferred reagents are disclosed herein above.

The term “changing conditions” refers to changes of physical, physicochemical and/or chemical parameters such as solvent, ionic strength, pH. The changed conditions are preferably such that an analyte of interest which is absorbed by the chromatographic material desorbs and can be retrieved in the eluate.

In an eighth aspect, the present invention provides a kit comprising or consisting of (a) a cartridge according to the first aspect; and (b) (i) a protease, preferably trypsin and/or Lys-C;

an alkylating agent, preferably chloroacetamide; a reducing agent, preferably a phosphine-based reducing agent; a standard for mass-spectrometric analysis; a chaotropic agent, preferably GdmCl, a detergent, preferably SDC; and/or means for establishing a pH-value in said container of between 7 and 9, preferably 8 and 9, more preferably 8.5; (ii) a nuclease, preferably an endonuclease; and/or reagents for nucleic acid amplification, preferably by PCR; and/or (iii) one or more buffers for loading, washing, and eluting of analytes of the chromatography material.

In a preferred embodiment, the kit further comprises (a) at least one of the following chemicals: bead-milling material, detergents, chaotropic agents, alkylating agents such as iodoacetamide, reducing agents, organic solvents, antioxidants, UV-absorbants, standards for mass-spectrometric analysis; (b) at least one of the following enzymes: protease, nuclease, decarboxylase, kinase, glycosidase; and/or (c) a manual with instructions for performing the method of the invention.

As regards the embodiments characterized in this specification, in particular in the claims, it is intended that each embodiment mentioned in a dependent claim is combined with each embodiment of each claim (independent or dependent) said dependent claim depends from. For example, in case of an independent claim 1 reciting 3 alternatives A, B and C, a dependent claim 2 reciting 3 alternatives D, E and F and a claim 3 depending from claims 1 and 2 and reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Similarly, and also in those cases where independent and/or dependent claims do not recite alternatives, it is understood that if dependent claims refer back to a plurality of preceding claims, any combination of subject-matter covered thereby is considered to be explicitly disclosed. For example, in case of an independent claim 1, a dependent claim 2 referring back to claim 1, and a dependent claim 3 referring back to both claims 2 and 1, it follows that the combination of the subject-matter of claims 3 and 1 is clearly and unambiguously disclosed as is the combination of the subject-matter of claims 3, 2 and 1. In case a further dependent claim 4 is present which refers to any one of claims 1 to 3, it follows that the combination of the subject-matter of claims 4 and 1, of claims 4, 2 and 1, of claims 4, 3 and 1, as well as of claims 4, 3, 2 and 1 is clearly and unambiguously disclosed.

The figures show:

FIG. 1: Cartridge of the invention with hydrophobic layers and a constant cross-section design. (1) Inlet and reaction volume (implementing items (a) and (b) of the main embodiment). (2) Top hydrophobic layer to prevent flow into chromatographic material of choice (implementing item (c)). (3) Chromatographic material (implementing item (d)). (4) Bottom hydrophobic layer to prevent backflow into chromatographic material from the bottom outside (implementing item (e)). (6) Outlet equipped with a grid (implementing item (f)).

FIG. 2: Cartridge of the invention with hydrophobic layers and a design similar to a syringe. (1) Inlet and reaction volume. (2) Top hydrophobic layer to prevent flow into chromatographic material of choice. (3) Chromatographic material. (4) Bottom hydrophobic layer to prevent backflow into chromatographic material from the bottom outside. (5) Outlet and bottom volume.

FIG. 3: Cartridge of the invention with a simple grid at the bottom.

The examples illustrate the invention.

### EXAMPLE 1

### Water Retention

### Materials and Methods

Various discs of alternating chemistries were tested for water retention (Tab. 1). For this purpose, discs of 15 mm² were filled into cartridges of a fill volume of max. 300 μl. The cartridges were filled with 300 μl ultrapure LC-MS grade water and were centrifuged at room temperature (24° C.) with alternating speed and time settings (Tab. 2). The flow-through was quantified after centrifugation to determine the efficiency of retention.

TABLE 1
Materials used for testing.

| | | Descrip- | | Hydropho- | |
|---|---|---|---|---|---|
| Materials | Manufacturer | tion | Discs | bicity | Wettability |
| 1 | 3M | SDB-XC | 1 | +++ | − |
| 2 | 3M | SDB-RPS | 1 | + | +++ |
| 3 | Piper Filter | PTFE | 1 | +++ | − |
| | GmbH | 1-2 μm | | | |
| 4 | Piper Filter | PTFE | 1 | +++ | − |
| | GmbH | 5-6 μm | | | |
| 5 | Piper Filter | PTFE | 2 | +++ | − |
| | GmbH | 1-2 μm | | | |
| 6 | 3M | Cation | 1 | − | +++ |
| 7 | 3M | Anion | 1 | − | +++ |
| 8 | 3M | Activated | 1 | +++ | − |
| | | Carbon | | | |
| 9 | 3M | C8 | 1 | ++ | − |
| 10 | 3M | C18 | 1 | +++ | − |

TABLE 2
Centrifugation settings for testing. 300 gₙ corresponds
to 0.6 bar pressure difference across the membrane.

| Condition | Acceleration [gₙ] | Time [s] | Temp. [° C.] |
|---|---|---|---|
| A | 100 | 60 | 24 |
| B | 300 | 60 | 24 |
| C | 500 | 60 | 24 |
| D | 1000 | 60 | 24 |
| E | 1000 | 90 | 24 |
| F | 300 | 600 | 24 |
| G | 300 | 3600 | 24 |

### Results and Discussion

All hydrophobic materials tested for short/high speed centrifugation displayed better liquid retention at low centrifugation speed. Highly hydrophobic and thick membranes (materials 1 and 5) display very good retention for short times at accelerations of up to 1,000 gₙ (corresponds to a pressure difference across the membrane of 1.9 bar; see Tab. 4 for the amount of liquid passing through the cartridge under the given conditions). More hydrophilic material (material 2) displays higher liquid retention at lower speed but a higher flow at higher speeds.

TABLE 4
Short centrifugation of few selected materials.

| Condition | 1 | | 2 | | 3 | | 4 | | 5 | |
|---|---|---|---|---|---|---|---|---|---|---|
| A | 0 | μl | 0 | μl | 0 | μl | 0 | μl | 0 | μl |
| B | 0 | μl | 10 | μl | 0 | μl | 100 | μl | 0 | μl |
| C | 0 | μl | 150 | μl | 150 | μl | 150 | μl | 0 | μl |
| D | 2 | μl | 290 | μl | 200 | μl | 200 | μl | 200 | μl |
| E | 10 | μl | 300 | μl | 280 | μl | 280 | μl | 280 | μl |

To test the overall retention over longer time periods longer centrifugation steps were tested with a broader spectrum of materials (Tab. 5). All highly hydrophobic materials except for PTFE 5-6 μm retain water at 300 gₙ for 1 h at room temperature. SAX (material 7) displayed delayed flow but did not withstand the long-term exposure to 300 g.

TABLE 5
Long term centrifugation.

| Condition | 1 | 2 | 3 | 4 | 5 | 6 | 7 | 8 | 9 | 10 |
|---|---|---|---|---|---|---|---|---|---|---|
| F | 0 | 300 | 0 | 300 | 0 | 300 | 10 | 0 | 0 | 0 |
| | μl | μl | μl | μl | μl | μl | μl | μl | μl | μl |
| G | 0 | 300 | 0 | 300 | 0 | 300 | 300 | 0 | 0 | 0 |
| | μl | μl | μl | μl | μl | μl | μl | μl | μl | μl |

Liquid retention was successfully achieved at centrifugation speeds up to 300 gₙ with hydrophobic materials and filtration pores below 5 μm. Large pores such as 5 μm would therefore need a higher surface energy as can be achieved with superhydrophobic materials or coatings. The backpressure of some materials (material 2 and 7) may delay the liquid flow across these hydrophilic membranes however all hydrophilic membranes did not retain water for extended periods of time. Hydrophobic membranes can therefore be used to selectively allow flow at predetermined flow forces and thereby control the entire procedure.

### EXAMPLE 2

### Chromatography

### Materials and Methods

Standard constructions for SCX and SAX chromatography were tested with and without a PTFE 1-2 μm membrane as bottom layer with and with and without PTFE 1-2 μm as top layer (Tab. 3). For this purpose, discs of 15 mm² were filled into cartridges of a fill volume of max. 300 μl. The cartridges were filled with 300 μl 1% acetic acid (AcOH) for SCX and 100 mM sodium hydroxide (NaOH) for SAX chromatography. To test liquid retention and selective loading, the cartridges were centrifuged at 500 gₙ for 1 min (PL1) and 10 min (PL2) at room temperature. Subsequently the cartridges were centrifuged at 3,000 gₙ for 1 min for analyte loading (L). The cartridges were then washed twice with 300 μl 0.1% AcOH for SCX and 10 mM NaOH for SAX chromatography at 3,000 gₙ for 1 min (W1, W2). The sample was then eluted with 300 μl 1% ammonium hydroxide (NH4) for SCX and 1% AcOH for SAX chromatography at 3.000 gₙ for 1 min (E).

TABLE 3
Materials used for testing. Layers numbered from top to bottom.

| Materials | Layer 1 | Layer 2 | Layer 3 |
|---|---|---|---|
| 11 | Cation (SCX) | — | — |
| 12 | Anion (SAX) | — | — |
| 13 | Cation (SCX) | PTFE 1-2 μm | — |
| 14 | Anion (SAX) | PTFE 1-2 μm | — |
| 15 | PTFE 1-2 μm | Cation (SCX) | PTFE 1-2 μm |
| 16 | PTFE 1-2 μm | Anion (SAX) | PTFE 1-2 μm |

### Results and Discussion

All combinations of membranes with a PTFE 1-2 μm (materials 13-16) retained the liquid at centrifugation at 500 gₙ for 10 min while the cartridges with chromatography material only did not retain the liquid even after 1 min at 500 gₙ centrifugation (materials 11, 12).

TABLE 6
Selective SCX and SAX chromatography flow using
hydrophobic membranes to retain liquid.

| Condition | PL1 | PL2 | L | W1 | W2 | E |
|---|---|---|---|---|---|---|
| 11 | 300 μl | 300 μl | 300 μl | 300 μl | 300 μl | 300 μl |
| 12 | 300 μl | 300 μl | 300 μl | 300 μl | 300 μl | 300 μl |
| 13 | 0 μl | 0 μl | 300 μl | 300 μl | 300 μl | 300 μl |
| 14 | 0 μl | 0 μl | 300 μl | 300 μl | 300 μl | 300 μl |
| 15 | 0 μl | 0 μl | 300 μl | 300 μl | 300 μl | 300 μl |
| 16 | 0 μl | 0 μl | 300 μl | 300 μl | 300 μl | 300 μl |

SCX and SAX chromatography can be selectively performed using predetermined centrifugation speeds without risk of prior flow. The flow can be controlled by centrifugation and can therefore be used to define which sample flows across the chromatography material at which stage.

1. A cartridge comprising or consisting of, from top to bottom, the following elements:
(a) an inlet;
(b) a top volume;
(c) at least one optional layer made of a first material;
(d) adjacent to (b) or, if present, to (c), at least one layer of chromatographic material;
(e) adjacent to (d) at least one layer made of first material; and
(f) an outlet;
wherein said first material is hydrophobic and porous.

2. The cartridge of claim 1, wherein the layers of (e) and, if present, of (c) prevent the flow of a polar liquid with a surface tension of at least 35 mN/m, at least 50 mN/m or at least 70 mN/m at ambient pressure and allow the flow of said polar liquid through said disk(s) at elevated pressure, and/or when vacuum and/or centrifugal force is applied.

3. The cartridge of claim 2, wherein said elevated pressure is at least 10 000 Pa above ambient pressure, preferably at least 100 000 Pa above ambient pressure, or a consequence of centrifugation with at least 50 gₙ or at least 500 gₙ, wherein said elevated pressure may be exerted from above and/or as vacuum from below, and wherein preferably said polar liquid is water.

4. The cartridge of any one of the preceding claims, wherein
(a) the pores of said first material have a width of between about 1 nm and about 20 μm, preferably between about 0.01 μm and about 5 μm, most preferred between about 0.22 μm and about 1 μm;
(b) the contact angle of water on a surface of said first material is at least 90 degrees, preferably at least 100 degrees, more preferably at least 110 degrees; and/or
(c) the surface energy of said first material is 70 mN/m or less, preferably 50 mN/m or less or 30 mN/m or less, more preferably about 20 mN/m or less.

5. The cartridge of any one of claims 1 to 4, wherein said first material of (e) and, if present, of (c), are independently selected
(a) from polytetrafluorethylene (PTFE), perfluoroalkoxy alkane (PFA), and fluorinated ethylene propylene (FEP), wherein preferably said material is provided as a membrane
(b) C18 material, C8 material, C4 material and benzene, wherein preferably said first material is bound to beads or to a membrane, and wherein more preferably said layer(s) is/are Empore™ SDB-XC extraction disks; and
(c) superhydrophobic particles made of manganese oxide polystyrene (MnO₂/PS) nano-composite, zinc oxide polystyrene (ZnO/PS) nano-composite, precipitated calcium carbonate, carbon nano-tube structure, and/or silica, wherein preferably said particles form a coating of said layer(s) of chromatographic material.

6. The cartridge of any one of the preceding claims, wherein
the segment of said cartridge comprising or consisting of elements (c), (d) and (e) has constant width and/or is cylindrical, wherein preferably said segment further comprises or further consists of element (b), and wherein more preferably said segment further comprises or further consists of elements (a) and/or (f).

7. The cartridge of any one of the preceding claims, wherein said layer of (c) is present, thereby rendering said top volume (b) a reaction volume.

8. Use of the cartridge of any one of the preceding claims for controlling flow of polar liquid through the chromatographic material of (d).

9. Use of the cartridge of any one of the preceding claims for preventing backflow of polar liquid from below the disk of (e) such as backflow of water from a water bath.

10. Use of the cartridge of any one of the preceding claims for storage of polar liquids, polar liquids preferably being biological samples, biological samples preferably comprising peptides, polypeptides and/or proteins.

11. Use of the cartridge of any one of the preceding claims, wherein said disk of (c) is present, for retaining polar liquids above said disk of (c).

12. Use of the cartridge of any one of the preceding claims for preventing the chromatographic material of (d) from drying, wherein drying is the loss of a polar liquid.

13. A method of sample preparation, said method comprising:
(a) transferring a sample to a cartridge of any one of the preceding claims via the inlet of said cartridge; and
(b) applying pressure, vacuum and/or centrifugal force;
thereby preparing said sample.

14. The method of claim 13, furthermore comprising one or both steps (aa) and (bb):
(aa) after step (a) and prior to step (b), adding one or more reagents and/or allowing (a) reaction(s) to occur, wherein preferably said layer (c) of said cartridge is present; and
(bb) collecting the eluate flowing from the outlet of said cartridge, optionally after changing conditions, said collecting optionally comprising fractionating.

15. A kit comprising or consisting of
(a) a cartridge according to any one of the preceding claims; and
(b) (i) a protease, preferably trypsin and/or Lys-C; an alkylating agent, preferably chloroacetamide; a reducing agent, preferably a phosphine-based reducing agent; a standard for mass-spectrometric analysis; a chaotropic agent, preferably GdmCl, a detergent, preferably SDC; and/or means for establishing a pH-value in said container of between 7 and 9, preferably 8 and 9, more preferably 8.5;
(ii) a nuclease, preferably an endonuclease; and/or reagents for nucleic acid amplification, preferably by PCR; and/or
(iii) one or more buffers for loading, washing, and eluting of analytes of the chromatography material.
